(19) United States
(12) Patent Application Publication
(10) Pub. No.: US 2022/0259701 A1
(43) Pub. Date: Aug. 18, 2022

(54) COPPER ALLOY TROLLEY WIRE

(71) Applicant: MITSUBISHI MATERIALS CORPORATION, Tokyo (JP)

(72) Inventors: Yoshiyuki Akiyama, Iwaki-shi (JP); Satoshi Kumagai, Sakai-shi (JP); Norikazu Ishida, Tokyo (JP); Tadanori Usuki, Kokubunji-shi (JP); Chikara Yamashita, Kokubunji-shi (JP)

(73) Assignee: MITSUBISHI MATERIALS CORPORATION, Tokyo (JP)

(21) Appl. No.: 17/624,637

(22) PCT Filed: Jun. 3, 2020
(86) PCT No.: PCT/JP2020/021905

§ 371 Date: Jan. 4, 2022

(30) Foreign Application Priority Data
Jul. 10, 2019 (JP) 2019-128391

(51) Int. Cl. C22C 9/00; C21D 9/52; C22F 1/08

(52) U.S. Cl. CPC C22C 9/00; C22F 1/08; C21D 9/525

(57) ABSTRACT

A copper alloy trolley wire is formed of a composition containing Mg in a range of 0.15% by mass or more and 0.50% by mass or less, Cr in a range of 0.25% by mass or more and 1.0% by mass or less, and a Cu balance containing inevitable impurities, in which a tensile strength is 600 MPa or higher and an electrical conductivity is 60% IACS or higher.

### TECHNICAL FIELD

The present invention relates to a copper alloy trolley wire able to be used as a trolley wire used in train line equipment for electric railroads.

Priority is claimed on Japanese Patent Application No. 2019-128391, filed Jul. 10, 2019 in Japan, the content of which is incorporated herein by reference.

### BACKGROUND ART

In the related art, the trolley wires described above are formed to make sliding contact with a current collector such as a pantograph and to supply power to an electric railroad vehicle or the like. In order to obtain good current collection performance, such as reduced separation from the pantograph, it is necessary for the wave propagation speed of the trolley wire to sufficiently exceed the running speed. Since the wave propagation speed of the trolley wire is proportional to the square root of the applied tension, a high strength trolley wire is necessary to improve the wave propagation speed. In addition, there is a demand for trolley wires to have excellent electrical conductivity, wear resistance, and fatigue characteristics.

In recent years, although the running speed of electric railroad vehicles has been increased, in high-speed railroads for bullet train or the like, if the running speed of an electric railroad vehicle is faster than 0.7 times the propagation speed of waves generated on overhead wires such as trolley wires, there is a concern that the contact between the trolley wires and the current collector such as a pantograph may become unstable, such that it is no longer possible to supply power therethrough in a stable manner.

Here, increasing the overhead wire tension of the trolley wire makes it possible to increase the propagation speed of the waves in the trolley wire, thus, there is a demand for a trolley wire with even higher strength than in the related art.

As copper alloy wires formed of copper alloys provided with high strength and high electrical conductivity which satisfy the in-demand characteristics described above, copper alloy wires containing Co, P and Sn were proposed, for example, as shown in Patent Document 1. In these copper alloy wires, precipitating compounds of Co and P in a copper matrix makes it possible to improve strength while maintaining electrical conductivity.

### CITATION LIST

### Patent Document

[Patent Document 1]
Japanese Unexamined Patent Application, First Publication No. 2014-025138 (A)

### SUMMARY OF INVENTION

### Technical Problem

Also, recently, the speed of electric railroad vehicles has further increased and there is a demand for excellent wear characteristics and fatigue characteristics beyond those in the related art.

Here, in the copper alloy trolley wire disclosed in Patent Document 1, the strength (hardness) is improved by precipitating compounds of Co and P in a copper matrix; however, it is not possible to further improve the strength (hardness) and it is difficult to sufficiently improve the wear characteristics and fatigue characteristics. In addition, in a case where the work ratio was increased to further improve the strength (hardness) by work hardening, there was a concern that use was not possible under high load conditions.

The present invention was created in consideration of the above circumstances and has an object of providing a copper alloy trolley wire having excellent electrical conductivity, sufficient strength and hardness, excellent fatigue characteristics, and which is able to be used under high load conditions.

### Solution to Problem

In order to solve this problem, the copper alloy trolley wire of an aspect of the present invention (referred to below as the “copper alloy trolley wire of the present invention”) is formed of a composition including Mg in a range of 0.15% by mass or more and 0.50% by mass or less, Cr in a range of 0.25% by mass or more and 1.0% by mass or less, and a Cu balance containing inevitable impurities, in which a tensile strength is 600 MPa or higher and an electrical conductivity is 60% IACS or higher.

In the copper alloy trolley wire with the configuration described above, since Mg is contained in the range described above, it is possible to sufficiently improve the strength by solution hardening.

In addition, since Cr is contained in the range described above, it is possible to further improve the strength (hardness) and electrical conductivity by dispersing Cr-based precipitates.

As a result, since the tensile strength is set to be 600 MPa or higher, the wear characteristics and fatigue characteristics are excellent. In addition, since the strength (hardness) is sufficiently excellent, it is possible to lower the work ratio during manufacturing and use is also possible under high load conditions.

Furthermore, since the electrical conductivity is set to be 60% IACS or higher, good current flow is possible.

Here, in the copper alloy trolley wire of the present invention, the Vickers hardness is preferably 180 Hv or higher.

In such a case, since the Vickers hardness is set to be 180 Hv or higher, the wear resistance is particularly excellent and it is possible to extend the life of the copper alloy trolley wire.

In addition, preferably, the copper alloy trolley wire of the present invention includes one or two or more additive elements selected from B, Zr, P, and Si, in which a total content of the additive elements is in a range of 5 mass ppm or more and 1000 mass ppm or less.

In such a case, since one or two or more additive elements selected from B, Zr, P, and Si are contained in a range of 5 mass ppm or more in total, it is possible to suppress coarsening of crystal grains during solution treatment, to finely and uniformly disperse precipitates by a subsequent aging heat treatment, and to further improve the strength (hardness) and electrical conductivity.

On the other hand, since the total content of the additive elements is 1000 mass ppm or less, it is possible to suppress a decrease in castability and the generation of casting cracks.

Furthermore, the copper alloy trolley wire of the present invention may contain B in a range of 5 mass ppm or more and 1000 mass ppm or less.

In addition, the copper alloy trolley wire of the present invention may contain Zr in a range of 5 mass ppm or more and 1000 mass ppm or less.

Furthermore, the copper alloy trolley wire of the present invention may contain P in a range of 5 mass ppm or more and 1000 mass ppm or less.

In addition, the copper alloy trolley wire of the present invention may contain Si in a range of 5 mass ppm or more and 1000 mass ppm or less.

In such cases, it is possible to suppress crystal grain coarsening when heated and held at high temperatures without decreasing castability or generating casting cracks. Thus, it is possible to finely and uniformly disperse precipitates by a subsequent aging heat treatment and to further improve the strength (hardness) and electrical conductivity.

### Advantageous Effects of Invention

According to the present invention, it is possible to provide a copper alloy trolley wire having excellent electrical conductivity, sufficient strength and hardness, excellent fatigue characteristics, and which is able to be used under high load conditions.

### BRIEF DESCRIPTION OF DRAWINGS

FIG. 1 is a flow diagram showing an example of a method for manufacturing a copper alloy trolley wire in an embodiment of the present invention.

### DESCRIPTION OF EMBODIMENTS

A description will be given below of a copper alloy trolley wire which is an embodiment of the present invention. The copper alloy trolley wire of the present embodiment is used, for example, in electric railroad vehicles or the like and has a nominal cross-sectional area perpendicular to the longitudinal direction in a range of 85 mm² or more and 170 mm² or less.

The copper alloy trolley wire which is an embodiment of the present invention is formed of a composition containing Mg in a range of 0.15% by mass or more and 0.50% by mass or less, Cr in a range of 0.25% by mass or more and 1.0% by mass or less, and a Cu balance containing inevitable impurities.

In the copper alloy trolley wire of the present embodiment, the tensile strength is 600 MPa or higher and the electrical conductivity is 60% IACS or higher.

In addition, in the copper alloy trolley wire of the present embodiment, the Vickers hardness is preferably 180 Hv or higher.

The copper alloy trolley wire of the present embodiment may further contain one or two or more additive elements selected from B, Zr, P, and Si, in which a total content of the additive elements may be in a range of 5 mass ppm or more and 1000 mass ppm or less.

In addition, the copper alloy trolley wire of the present embodiment may contain B in a range of 5 mass ppm or more and 1000 mass ppm or less.

Here, a description will be given below of the reasons for specifying the component composition and various characteristics in the copper alloy trolley wire of the present embodiment as described above.

### (Mg: 0.15% by Mass or More and 0.50% by Mass or Less)

Mg is an element which has an action of sufficiently improving strength by forming a solid solution in the matrix of the copper alloy.

Here, in a case where the content of Mg is less than 0.15% by mass, there is a concern that the action and effect of Mg may not be sufficiently exhibited. On the other hand, in a case where the content of Mg is more than 0.50% by mass, there is a concern that the electrical conductivity may decrease significantly, the viscosity of the molten copper alloy may increase, and the castability may decrease.

For these reasons, in the present embodiment, the content of Mg is set in a range of 0.15% by mass or more and 0.50% by mass or less.

In order to further improve the strength, the lower limit of the content of Mg is preferably set to 0.30% by mass or more, and more preferably set to 0.40% by mass or more. On the other hand, in order to reliably suppress a decrease in electrical conductivity and a decrease in castability, the upper limit of the content of Mg is preferably set to 0.45% by mass or less.

### (Cr: 0.25% by Mass or More and 1.0% by Mass or Less)

Cr is an element which has an action and effect of improving hardness (strength) and electrical conductivity by causing fine precipitation of Cr-based precipitates (for example, Cu—Cr) in the crystal grains of the matrix through an aging treatment.

Here, in a case where the content of Cr is less than 0.25% by mass, there is a concern that the amount of precipitation during the aging treatment may be insufficient and the effect of improving hardness (strength) and electrical conductivity may not be sufficiently obtained. In addition, in a case where the content of Cr is more than 1.0% by mass, there is a concern that comparatively coarse Cr crystallized products may be formed, which may cause defects.

Due to the above, in the present embodiment, the content of Cr is set in a range of 0.25% by mass or more and 1.0% by mass or less.

In order to reliably exhibit the action and effects described above, the lower limit of the content of Cr is preferably set to 0.30% by mass or more, and more preferably set to 0.40% by mass or more. On the other hand, in order to further suppress the formation of comparatively coarse Cr crystallized products and to further suppress the generation of defects, the upper limit of the content of Cr is preferably set to 0.70% by mass or less, and more preferably set to 0.60% by mass or less.

(Total Content of One or Two or More Additive Elements Selected from B, Zr, P, and Si: 5 Mass Ppm or More and 1000 Mass Ppm or Less)

One or two or more additive elements selected from B, Zr, P, and Si are elements which have an action of suppressing crystal grain coarsening when held at high temperatures.

Here, setting the total content of the additive elements described above to 5 mass ppm or more makes it possible to sufficiently exhibit the action and effect described above. On the other hand, setting the total content of the additive elements described above to 1000 mass ppm or less makes it possible to suppress the decrease in castability and the generation of casting cracks.

Thus, in the copper alloy trolley wire of the present embodiment, in order to suppress crystal grain coarsening when held at high temperatures, the total content of one or two or more additive elements selected from B, Zr, P, and Si is preferably set in a range of 5 mass ppm or more and 1000 mass ppm or less.

The lower limit of the total content of the additive elements described above is more preferably set to 10 mass ppm or more, and even more preferably 20 mass ppm or more. In addition, the upper limit of the total content of the additive elements described above is more preferably 500 mass ppm or less, and even more preferably 300 mass ppm or less.

In addition, in a case where the additive elements described above are not intentionally added, the total content of the additive elements described above may be less than 5 mass ppm.

### (B: 5 Mass Ppm or More and 1000 Mass Ppm or Less)

B is an element which has an effect of suppressing crystal grain coarsening when held at high temperatures.

Here, setting the content of B to 5 mass ppm or more makes it possible to sufficiently exhibit the action and effects described above. On the other hand, setting the content of B to 1000 mass ppm or less makes it possible to suppress a decrease in castability and the generation of casting cracks.

Therefore, in the copper alloy trolley wire of the present embodiment, in order to suppress crystal grain coarsening when held at high temperatures, the content of B is preferably set in a range of 5 mass ppm or more and 1000 mass ppm or less.

The lower limit of the content of B is more preferably set to 10 mass ppm or more, and even more preferably 20 mass ppm or more. In addition, the upper limit of the content of B is more preferably 50 mass ppm or less, and even more preferably 30 mass ppm or less.

In addition, in a case where B is not intentionally added, the content of B may be less than 5 mass ppm.

### (Other Inevitable Impurities)

Examples of other inevitable impurities other than Mg, Cr, and the like described above include Al, Fe, Ni, Zn, Mn, Co, Ti, (B), Ag, Ca, (Si), Te, Sr, Ba, Sc, Y, Ti, (Zr), Hf, V, Nb, Ta, Mo, W, Re, Ru, Os, Se, Rh, Ir, Pd, Pt, Au, Cd, Ga, In, Li, Ge, As, Sb, Tl, Pb, Be, N, H, Hg, Tc, Na, K, Rb, Cs, Po, Bi, lanthanoids, O, S, C, (P), and the like. Since there is a concern that these inevitable impurities may decrease the electrical conductivity (thermal conductivity), the total amount thereof is preferably 0.05% by mass or less.

### (Tensile Strength: 600 MPa or Higher)

In the copper alloy trolley wire of the present embodiment, in a case where the tensile strength is less than 600 MPa, there is a concern that the strength may be insufficient and that it may not be possible to use the wire as a trolley wire.

For this reason, the tensile strength of the copper alloy trolley wire of the present embodiment is set to be 600 MPa or higher.

The tensile strength of the copper alloy trolley wire of the present embodiment is preferably set to 630 MPa or higher, and even preferably set to 650 MPa or higher.

The upper limit value of the tensile strength of the copper alloy trolley wire is not particularly limited, but is able to be set to 750 MPa or less.

### (Electrical Conductivity: 60% IACS or Higher)

In the copper alloy material of the present embodiment, in a case where the electrical conductivity is less than 60% IACS, there is a concern that good current flow may not be possible and that it may not be possible to use the wire as a trolley wire.

For this reason, the copper alloy trolley wire of the present embodiment has an electrical conductivity which is set to be 60% IACS or higher.

The electrical conductivity of the copper alloy material of the present embodiment is preferably set to 63% IACS or higher, and more preferably set to 65% IACS or higher.

The upper limit value of the electrical conductivity of the copper alloy trolley wire is not particularly limited, but is able to be set to 85% IACS or lower.

### (Vickers Hardness: 180 Hv or Higher)

In the copper alloy trolley wire of the present embodiment, in a case where the Vickers hardness is 180 Hv or higher, it is possible to secure sufficient wear resistance and to extend the service life of the copper alloy trolley wire.

In view of the above, the copper alloy trolley wire of the present embodiment preferably has a Vickers hardness of 180 Hv or higher.

The Vickers hardness of the copper alloy material of the present embodiment is more preferably 190 Hv or higher, and even more preferably 200 Hv or higher.

The upper limit value of the Vickers hardness of the copper alloy trolley wire is not particularly limited but is able to be set to 250 Hv or less.

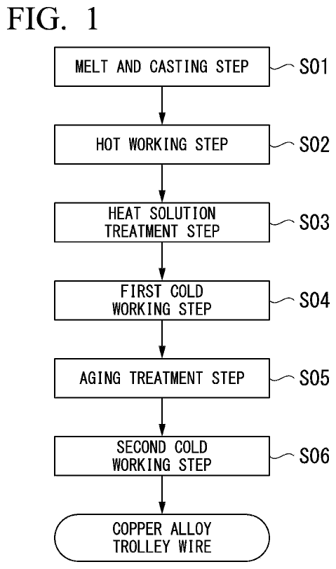

Next, a description will be given of a method for manufacturing a copper alloy trolley wire according to an embodiment of the present invention with reference to the flow diagram in FIG. 1.

### (Melting and Casting Step S01)

First, a copper raw material formed of oxygen-free copper with a copper purity of 99.99% by mass or more is charged into a carbon crucible and melted using a vacuum melting furnace to obtain molten copper. Next, a molten copper alloy is obtained by adjusting the composition to achieve predetermined concentrations of Mg and Cr by adding them to the obtained molten metal.

Here, as raw materials for Mg and Cr, for example, it is preferable to use an Mg raw material with a purity of 99.9% by mass or more and to use a Cr raw material with a purity of 99.9% by mass or more. A Cu—Mg matrix alloy or a Cu—Cr matrix alloy may also be used.

Then, the molten copper alloy in which the components are prepared is poured into a mold to obtain a copper alloy ingot.

### (Hot Working Step S02)

Next, the obtained copper alloy ingot is subjected to hot working. Here, the hot working conditions are preferably a temperature: 800° C. or higher and 1000° C. or lower, and a working rate: 10% or more and 99% or less. In addition, after the hot working, cooling is carried out immediately by water cooling.

The processing method in the hot working step S02 is not particularly limited, but extrusion or groove rolling is preferably applied thereto.

### (Solution Treatment Step S03)

Next, the hot-worked material obtained in the hot working step S02 is subjected to a solution treatment by heating under conditions of a holding temperature: 900° C. or higher and 1050° C. or lower, and a holding time at the holding temperature: 0.5 hours or more and 5 hours or less, followed by water cooling. The heating is preferably performed in air or an inert gas atmosphere, for example.

### (First Cold Working Step S04)

Next, cold working is performed on the solution-treated material subjected to the solution treatment step S03. Here, in the first cold working step S04, it is preferable to set the work ratio in a range of 10% or more and 99% or less.

The processing method in the first cold working step S04 is not particularly limited, but extrusion or groove rolling is preferably applied thereto.

### (Aging Treatment Step S05)

Next, a cold-worked material obtained in the cold working step S04 is subjected to an aging treatment to finely precipitate Cr-based precipitates.

Here, the aging treatment is preferably performed under conditions of a holding temperature: 400° C. or higher and 500° C. or lower and a holding time at the holding temperature: 1 hour or more and 6 hours or less. The heat treatment method during the aging treatment is not particularly limited, but is preferably performed in an inert gas atmosphere. In addition, the cooling method after heating is not particularly limited, but rapid cooling by water cooling is preferable.

### (Second Cold Working Step S06)

Next, cold working is carried out on the aging treated material subjected to the aging treatment step S05. Here, in the second cold working step S06, the work ratio is preferably set in a range of 5% or more and 80% or less.

The processing method in the second cold working step S06 is not particularly limited, but extrusion or groove rolling is preferably applied thereto.

The copper alloy trolley wire of the present embodiment is manufactured through these steps.

According to the copper alloy trolley wire of the present embodiment configured as described above, since Mg is contained in a range of 0.15% by mass or more and 0.50% by mass or less, it is possible to sufficiently improve the strength (hardness) by solution hardening.

In addition, since Cr is contained in a range of 0.25% by mass or more and 1.0% by mass or less, it is possible to further improve the strength (hardness) and electrical conductivity by dispersing Cr-based precipitates.

Since the tensile strength is set to be 600 MPa or higher, the wear characteristics and fatigue characteristics are excellent. In addition, since the strength is sufficiently excellent, it is possible to lower the work ratio during manufacturing and use is also possible under high load conditions.

Furthermore, since the electrical conductivity is set to be 60% IACS or higher, good current flow is possible.

In addition, in a case where the Vickers hardness is set to be 180 Hv or higher in the present embodiment, the wear resistance is particularly excellent and it is possible to extend the service life of the copper alloy trolley wire of the present embodiment.

Furthermore, in the present embodiment, in a case where one or two or more additive elements selected from B, Zr, P, and Si are contained and the total content of the additive elements is set in a range of 5 mass ppm or more and 1000 mass ppm or less, it is possible to suppress crystal grain coarsening in the solution treatment step S03, to finely and uniformly disperse the precipitates by the subsequent aging treatment step S05, and to further improve the strength and electrical conductivity. In addition, it is possible to suppress a decrease in castability and the generation of casting cracks.

Alternatively, in the present embodiment, even in a case where B is contained in a range of 5 mass ppm or more and 1000 mass ppm or less, it is possible to suppress crystal grain coarsening in the solution treatment step S03, to finely and uniformly disperse the precipitates by the subsequent aging treatment step S05, and to further improve the strength and electrical conductivity. In addition, it is possible to suppress a decrease in castability and the generation of casting cracks.

Although embodiments of the present invention were described above, the present invention is not limited thereto and appropriate changes are possible in a range not departing from the technical concept of the invention.

For example, the method of manufacturing the copper alloy material is not limited to the present embodiment and the manufacturing may be carried out by other manufacturing methods. For example, a continuous casting apparatus may be used in the melting and casting step.

### Examples

A description will be given below of the results of confirmation experiments conducted to confirm the effectiveness of the present invention.

A copper raw material formed of oxygen-free copper with a purity of 99.99% by mass or more was prepared, charged into a carbon crucible, and melted in a vacuum melting furnace (vacuum degree of 10⁻² Pa or less) to obtain molten copper. Various additive elements were added into the obtained molten copper to adjust the component compositions shown in Table 1 and, after being held for 5 minutes, the molten copper alloy was poured into a cast iron mold to obtain a copper alloy ingot. The cross-sectional dimensions of the copper alloy ingot were approximately 60 mm in width and 100 mm in thickness.

Regarding the additive elements, a raw material of Mg with a purity of 99.9% by mass or more and a raw material of Cr with a purity of 99.99% by mass or more were used.

Next, the obtained copper alloy ingot was subjected to hot rolling to obtain a hot-rolled material. The hot-rolling conditions were set at a temperature of 1000° C. and a work ratio of 90%.

The hot-rolled material was heated and held under the conditions shown in Table 2 and then water-cooled and subjected to a solution treatment.

Next, the solution-treated material described above was cut and subjected to cold working (drawing working) to obtain a cold-worked material. The work ratio was 60%.

This cold-worked material was heated and held in an atmospheric furnace under the conditions shown in Table 2 and then water-cooled and subjected to an aging treatment.

The obtained aging treated material was subjected to cold working (drawing working) and various copper alloy materials were obtained. The work ratio was 60%.

The obtained copper alloy materials were evaluated for component composition, tensile strength, electrical conductivity, fatigue characteristics, and wear resistance.

### (Component Composition)

The component compositions of the obtained copper alloy materials were measured by ICP-AES analysis. As a result, it was confirmed that the compositions were as shown in Table 1.

### (Tensile Strength)

Using an AG-X 250 kN manufactured by Shimadzu Corporation, after setting the distance between the test points to 250 mm, a tensile test was conducted two or more times at a crosshead speed of 100 mm/min and the average value thereof was obtained. The evaluation results are shown in Table 2.

### (Electrical Conductivity)

Using SIGMA TEST D2.068 (probe diameter: φ6 mm) manufactured by Foerster Japan Ltd., the center portion of the cross-section of a 10×15 mm sample was measured three times and the average value thereof was obtained. The evaluation results are shown in Table 2.

### (Vickers Hardness)

In accordance with JIS Z 2244, the Vickers hardness was measured at nine locations on a test piece by a Vickers hardness tester manufactured by Akashi Co., Ltd., and the average value of the seven measured values excluding the maximum value and minimum value was obtained. The evaluation results are shown in Table 2.

### (Wire Drawability)

The solution-treated material described above was subjected to cold drawing with a work ratio of 90% to work a copper wire material with a diameter of 2.6 mm. As the wire drawability, a value was used in which the number of times the wire was broken when wire drawing work was carried out until the wire was drawn to a length of 500 m with a diameter of 2.6 mm was evaluated and converted into the number of wire breakages caused per 10 m of the material. Cases with zero wire breakages were classified as “A” and cases in which wire breakages were generated were classified as “B”. The evaluation results are shown in Table 2.

### (Fatigue Characteristics)

A sheet material of 10 mm in width and 4 mm in thickness was cut out from the solution material after solution treatment and subjected to cold rolling at a work ratio of 50% to set the thickness to 2 mm. Thereafter, an aging heat treatment was carried out using an atmospheric furnace under the conditions shown in Table 2, cold rolling was performed at a work ratio of 75% to a thickness of 0.5 mm, and the result was cut to a length of 60 mm using shears. Then, burrs on the end face of the obtained test piece were removed using 1500-grit emery paper.

Then, the test pieces were set in a thin plate fatigue testing machine with a set length of 30 mm in accordance with the fatigue characteristic testing method for thin plates and strips of the Japan Copper and Brass Association (JCBA T308:2002). The frequency was 50 Hz, the strain amplitude was varied, and the number of vibrations until breaking was measured.

The ratio of the amplitude with respect to the set length of the test piece was defined as the strain amplitude and the breaking life was evaluated under the condition that the strain amplitude was 6×10⁻². Specifically, under the condition of 6×10⁻² strain amplitude, cases in which the number of vibrations up to breaking was 1.2×10⁷ times or more were evaluated as “A+”, while, with less than 1.2×10⁷ times, cases of 10⁷ times or more were evaluated as “A”, and cases of less than 10⁷ times were evaluated as “B”.

The evaluation results are shown in Table 2.

TABLE 1

| | | Composition (Mass Ratio) | | | | | | | |
|---|---|---|---|---|---|---|---|---|---|
| | | | | | | | | Total content | |
| | | Mg | Cr | B | Zr | P | Si | mass ppm of | |
| | | mass % | mass % | mass ppm | mass ppm | mass ppm | mass ppm | B, Zr, P, Si | Cu |
| Invention | 1 | 0.47 | 0.38 | — | — | — | — | 0 | Balance |
| Example | 2 | 0.18 | 0.39 | — | — | — | — | 0 | Balance |
| | 3 | 0.31 | 0.98 | — | — | — | — | 0 | Balance |
| | 4 | 0.41 | 0.28 | — | — | — | — | 0 | Balance |
| | 5 | 0.40 | 0.40 | — | — | — | — | 0 | Balance |
| | 6 | 0.41 | 0.39 | 100 | — | — | — | 100 | Balance |
| | 7 | 0.40 | 0.38 | — | 920 | — | — | 920 | Balance |
| | 8 | 0.41 | 0.40 | — | 50 | — | — | 50 | Balance |
| | 9 | 0.39 | 0.39 | — | — | 880 | — | 880 | Balance |
| | 10 | 0.36 | 0.36 | — | — | 40 | — | 40 | Balance |
| | 11 | 0.42 | 0.39 | — | — | — | 30 | 30 | Balance |
| | 12 | 0.40 | 0.38 | — | 90 | 50 | — | 140 | Balance |
| Comparative | 1 | 0.83 | 0.41 | — | — | — | — | 0 | Balance |
| Example | 2 | 0.09 | 0.42 | — | — | — | — | 0 | Balance |
| | 3 | 0.40 | 1.41 | — | — | — | — | 0 | Balance |
| | 4 | 0.35 | 0.20 | 100 | — | — | — | 100 | Balance |

TABLE 2

| | | Manufacturing Steps | | | | Evaluation | | | | |
|---|---|---|---|---|---|---|---|---|---|---|
| | | Solution treatment | | Aging treatment | | Tensile | Electrical | Vickers | | |
| | | Temperature | Time | Temperature | Time | strength | conductivity | hardness | Wire | Fatigue |
| | | (° C.) | (h) | (° C.) | (h) | (MPa) | (% IACS) | (Hv) | drawability | characteristics |
| Invention | 1 | 950 | 1 | 425 | 2 | 660 | 64.5 | 192 | A | A |
| Example | 2 | 950 | 1 | 425 | 2 | 605 | 78.1 | 183 | A | A |
| | 3 | 950 | 1 | 425 | 2 | 663 | 68.6 | 197 | A | A |
| | 4 | 975 | 1 | 425 | 2 | 613 | 66.6 | 188 | A | A |
| | 5 | 1000 | 1 | 425 | 2 | 660 | 68.2 | 203 | A | A+ |
| | 6 | 1000 | 1 | 425 | 2 | 640 | 62.0 | 131 | A | A+ |
| | 7 | 1000 | 1 | 425 | 2 | 661 | 61.1 | 202 | A | A+ |
| | 8 | 1000 | 1 | 425 | 2 | 649 | 68.2 | 204 | A | A+ |
| | 9 | 1000 | 1 | 425 | 2 | 652 | 62.3 | 198 | A | A+ |
| | 10 | 1000 | 1 | 425 | 2 | 647 | 68.1 | 200 | A | A+ |
| | 11 | 1000 | 1 | 425 | 2 | 638 | 63.6 | 191 | A | A+ |
| | 12 | 1000 | 1 | 425 | 2 | 649 | 67.5 | 202 | A | A+ |
| Comparative | 1 | 950 | 1 | 425 | 2 | 681 | 52.2 | 210 | A | A |
| Example | 2 | 975 | 1 | 425 | 2 | 572 | 82.1 | 177 | A | B |
| | 3 | 975 | 1 | 425 | 2 | 674 | 66.0 | 199 | B | A |
| | 4 | 975 | 1 | 425 | 2 | 562 | 71.4 | 175 | A | B |

In Comparative Example 1, in which the content of Mg was higher than the range of the present invention, the electrical conductivity was comparatively low at 52.2% IACS.

In Comparative Example 2, in which the content of Mg was less than the range of the present invention, the tensile strength was comparatively low at 572 MPa and the fatigue characteristics were low.

In Comparative Example 3, in which the content of Cr was higher than the range of the present invention, the wire drawability was “B.”

In Comparative Example 4, in which the content of Cr was lower than the range of the present invention, the tensile strength was comparatively low at 562 MPa and the fatigue characteristics were low.

On the other hand, in the Invention Examples 1 to 12, it was confirmed that the electrical conductivity was excellent, the strength was sufficient, and the wire drawability and fatigue characteristics were excellent.

### INDUSTRIAL APPLICABILITY

It is possible to provide a copper alloy trolley wire having excellent electrical conductivity, sufficient strength and hardness, excellent fatigue characteristics, and which is able to be used under high load conditions.

1. A copper alloy trolley wire formed of a composition comprising:
Mg in a range of 0.15% by mass or more and 0.50% by mass or less;
Cr in a range of 0.25% by mass or more and 1.0% by mass or less; and
a Cu balance containing inevitable impurities,
wherein a tensile strength is 600 MPa or higher and an electrical conductivity is 60% IACS or higher.

2. The copper alloy trolley wire according to claim 1, wherein a Vickers hardness is 180 Hv or more.

3. The copper alloy trolley wire according to claim 1, further comprising:
one or two or more additive elements selected from B, Zr, P, and Si,
wherein a total content of the additive elements is in a range of 5 mass ppm or more and 1000 mass ppm or less.

4. The copper alloy trolley wire according to claim 1, further comprising:
B in a range of 5 mass ppm or more and 1000 mass ppm or less.

5. The copper alloy trolley wire according to claim 1, further comprising:
Zr in a range of 5 mass ppm or more and 1000 mass ppm or less.

6. The copper alloy trolley wire according to claim 1, further comprising:
P in a range of 5 mass ppm or more and 1000 mass ppm or less.

7. The copper alloy trolley wire according to claim 1, further comprising:
Si in a range of 5 mass ppm or more and 1000 mass ppm or less.
